(19) United States
(12) Patent Application Publication
(10) Pub. No.: US 2008/0295183 A1
(43) Pub. Date: Nov. 27, 2008

(54) Playback Device, Method and Program, and Recording Medium

(76) Inventors: Shuji Okamoto, Hiroshima (JP); Yoichi Yamamoto, Hiroshima (JP)

Correspondence Address: WENDEROTH, LIND & PONACK L.L.P., 2033 K. STREET, NW, SUITE 800, WASHINGTON, DC, 20006, US

(21) Appl. No.: 11/547,976

(22) PCT Filed: Apr. 15, 2005
(86) PCT No.: PCT/JP05/07660

§ 371 Date: Oct. 10, 2006

(30) Foreign Application Priority Data
Apr. 16, 2004 (JP) 2004-121099

(51) Int. Cl. G06F 21/00

(52) U.S. Cl. 726/31

(57) ABSTRACT

A playback device for playing a video content selected from a plurality of video contents includes a first creating unit that creates a thumbnail for each video content without a copy restriction by reducing a frame image constituting the video content, a second creating unit that creates an index for each video content with a copy restriction by using one of a character string and a figure relating to the video content, and an output unit that outputs a thumbnail screen obtained by arranging thumbnails created by the first creating unit and indexes created by the second creating unit to another device.

### TECHNICAL FIELD

The present invention relates to copyright protection technology regarding a thumbnail screen for a plurality of video contents.

### BACKGROUND ART

Following diversification of the content industry, improvement in the selection function that allows desired items to be quickly chosen from a plurality of contents is now being sought in playback devices. Program Navigation is a typical example of such a selection function. Here, Program Navigation is technology for creating thumbnails for a plurality of video contents, placing the thumbnails on a thumbnail screen (i.e. list of thumbnail images), and playing video contents corresponding to thumbnails selected by a user. Thumbnails are obtained here by reducing any of a plurality of frame images constituting a video content.

If the video contents for thumbnail display are broadcast contents, it is possible that video contents with a copy restriction will be displayed on the same thumbnail screen as video contents without a copy restriction. A satisfactory solution to the problem of how to handle the copying of such a thumbnail screen was not reached in the prior art.

Here, the “copying” of a thumbnail screen includes recording by a recording device and printing by a photo printer with respect to the playback output of a playback device.

Allowing the copying of a thumbnail screen that includes even one video content with a copy restriction unfairly disadvantages the copyright holder in favor of the user. On the other hand, prohibiting the copying of the thumbnail screen advantages the copyright holder.

The ideal solution is “partial copying” in which part of the thumbnail screen is prohibited from copying, while copying of the remainder is permitted. However, copy restriction information (hereinafter “CRI”) for restricting copying is set for video frame periods and field periods, meaning that copy controls can only be realized for whole frames. This technological barrier to copy controls has meant that conventionally the handling of thumbnail screen copying has been biased in favor of either the user or the copyright holder.

### DISCLOSURE OF THE INVENTION

The present invention, arrived at in view of the above problems, aims to provide a playback device for realizing copy controls that balance the benefits to both users and copyright holders.

To achieve the above object, the present invention is a playback device for playing a video content selected from a plurality of video contents. The playback device includes: a first creating unit operable to create a thumbnail for each video content without a copy restriction by reducing a frame image constituting the video content; a second creating unit operable to create an index for each video content with a copy restriction by using one of a character string and a figure that relate to the video content; and an output unit operable to output to another device a thumbnail screen obtained by arranging thumbnails created by the first creating unit and indexes created by the second creating unit.

According to the above structure, the present invention uses a character string or a figure that relates to a video content having a copy restriction to create an index, and reduces one of a plurality of frame images constituting a video content that has no copy restriction to create a thumbnail. Thus the benefits to the copyright holder can be protected even if the thumbnail screen is output to another device. Allowing the thumbnail screen to be copied means that the benefits to the user can also be protected.

Here, the character string may indicate one of a title and a broadcast date of the video content, and the figure may indicate one of a genre of the video content and that copying of the video content is prohibited.

This enables information relating to a video content with a copy restriction to be output as an index.

Here, the playback device may further include a judging unit operable to judge whether the other device has a copy function that includes at least one of recording and printing the thumbnail screen, and the output unit may output the thumbnail screen obtained by arranging thumbnails and indexes created by the first and second creating units if the other device is judged to have the copy function.

Here, the playback device may further include a third creating unit operable to create a thumbnail for each video content with a copy restriction by reducing a frame image constituting the video content, and the output unit may output a thumbnail screen obtained by arranging thumbnails created by the first and third creating units to the other device only if judged not to have the copy function.

This enables the thumbnail screen for outputting to be determined depending on whether the other device has a copy function. If the output destination has no copy function, the playback device outputs a thumbnail screen that includes thumbnails created by reducing a frame image of video contents with a copy restriction. If connected to a device having a copy function, on the other hand, the playback device outputs a thumbnail screen that includes indexes created using a character string or a figure relating to the video contents with a copy restriction. Convenience to the user can thus be improved while at the same time protecting the rights of the copyright holder.

Here, the playback device may further include a third creating unit operable to create a thumbnail for each video content with a copy restriction by reducing a frame image constituting the video content, and a detecting unit operable to detect a copy operation. The output unit may output the thumbnail screen obtained by arranging thumbnails created by the first and third creating units until the copy operation is detected, and output the thumbnail screen obtained by arranging thumbnails and indexes created by the first and second creating units if the copy operation is detected.

According to this structure, a thumbnail screen that includes thumbnails created from both video contents with and without copy restrictions is output until such time that a copy operation is detected. The user is thus able to intuitively grasp the subject matter of individual video contents.

A display device pertaining to the present invention is used in a system that includes a playback device. The display device includes: a receiving unit operable to receive from the playback device a thumbnail, content information and copy restriction information that relate to each of a plurality of video contents; a judging unit operable to judge whether the video content has a copy restriction by referring to the copy restriction information; an index creating unit operable, if judged in the affirmative, to create an index using one of a character string and a figure included in the content information; and a display unit operable to display a thumbnail screen obtained by arranging thumbnails received by the receiving unit and indexes created by the index creating unit.

This structure enables the thumbnail screen to be created at the display device.

### BRIEF DESCRIPTION OF THE DRAWINGS

FIG. 1 is a system diagram;

FIG. 2 shows the functional blocks of a record/playback device pertaining to the present invention;

FIG. 3 shows the structure of an output control unit;

FIG. 4 shows exemplary content management information;

FIG. 5 shows exemplary content information;

FIG. 6 shows the items included in copy restriction information;

FIG. 7 shows a flowchart of a thumbnail display control;

FIG. 8 shows a flowchart of thumbnail display control;

FIG. 9 shows a thumbnail screen for a plurality of video contents;

FIG. 10 shows a thumbnail screen in which titles are displayed instead of copy-prohibited thumbnails;

FIG. 11 shows a thumbnail screen in which titles are overlaid on copy-prohibited thumbnails;

FIG. 12 shows a thumbnail screen in which copy-prohibited thumbnails are not displayed;

FIG. 13 shows a flowchart in the case of copy-prohibited thumbnails not being displayed;

FIG. 14 shows a flowchart in the case of copy-prohibited thumbnails not being displayed;

FIG. 15 shows the structure of an output control unit in an embodiment 2;

FIG. 16 is a flowchart showing the operations of a record/playback device in embodiment 2;

FIG. 17 shows a copy start window;

FIG. 18 shows the functional blocks of a record/playback device pertaining to an embodiment 3;

FIG. 19 shows a communication sequence between devices during device authentication;

FIG. 20 shows data transmission when a record/playback device requests device information and when a digital TV sends requested device information;

FIG. 21 shows device information;

FIG. 22 shows exemplary device category codes;

FIG. 23 shows a flowchart of device authentication;

FIG. 24 shows the functional blocks of a record/playback device in an embodiment 4;

FIG. 25 shows the functional blocks of a digital TV in embodiment 4;

FIG. 26 shows extended copy restriction information;

FIG. 27 shows an exemplary display format for thumbnails when using BML;

FIG. 28 shows an exemplary display format for thumbnails when using BML; and

FIG. 29 shows a thumbnail screen in which figures expressing the genre of video contents are displayed instead of copy-prohibited thumbnails.

### BEST MODE FOR CARRYING OUT THE INVENTION

### Embodiment 1

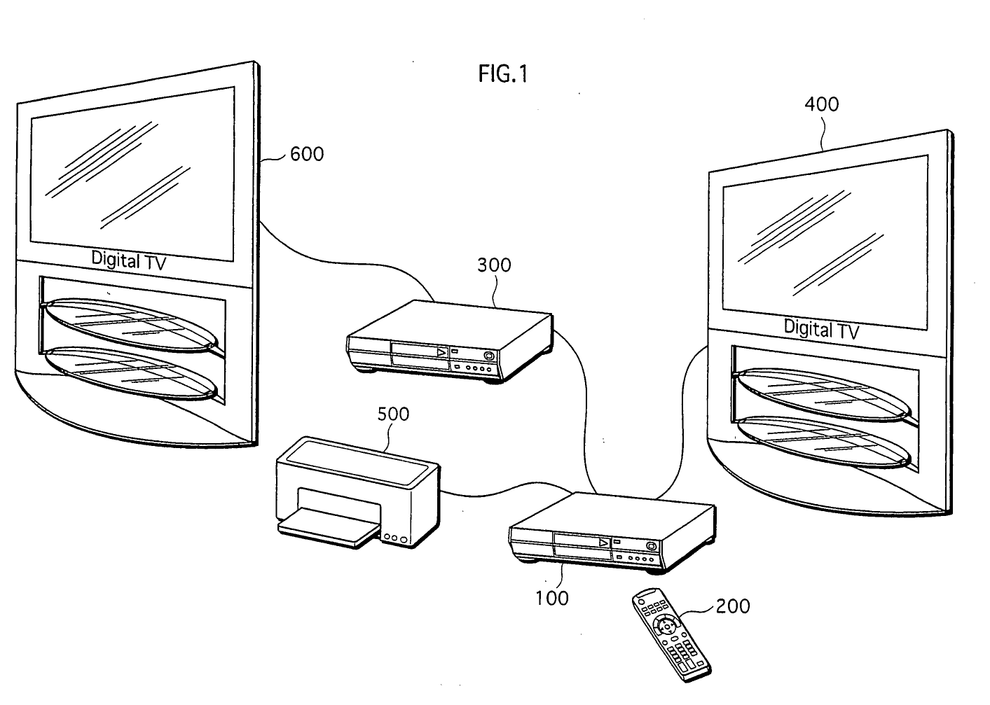

Embodiments of a playback device pertaining to the present invention are described below in terms of a record/playback (RP) device 100 that includes a recording function for recording broadcasted video contents. The applicability of RP device 100 is described firstly. RP device 100 is provided for the use of a user in a system as shown in FIG. 1. The system shown in FIG. 1 includes a record/playback (RP) device 300, a digital television (TV) 400, a photo printer 500, and a digital television (TV) 600.

RP device 100 receives broadcasted video contents and writes the received video contents to a recording medium. The recording medium is able to store a plurality of video contents, and RP device 100 is able to create a thumbnail screen for the video contents. RP device 100 is also able to output the created thumbnail screen to any of a plurality of devices connected thereto; namely, RP device 300, digital TV 400 and photo printer 500.

RP device 300 has a recording function, and is able to record to a recording medium a thumbnail screen for video contents sent by RP device 100. RP device 300 is also able to send the received thumbnail screen to digital TV 600 connected thereto.

Digital TV 400, which is a television receiver controlled using software and having a built-in digital tuner, displays the playback output of RP device 100. Digital TV 400 is able to receive a thumbnail screen for video contents sent by RP device 100 and display the received thumbnail screen.

Photo printer 500 is directly connected to RP device 100, and prints data sent by RP device 100. Photo printer 500 is able to print a thumbnail screen for video contents received from RP device 100.

Digital TV 600 connected to RP device 300 is a television receiver controlled using software and having a built-in digital tuner. Digital TV 600 is able to receive a thumbnail screen for video contents sent by RP device 300 and display the received thumbnail screen.

Thus completes description of the applicability of RP device 100.

### Structure

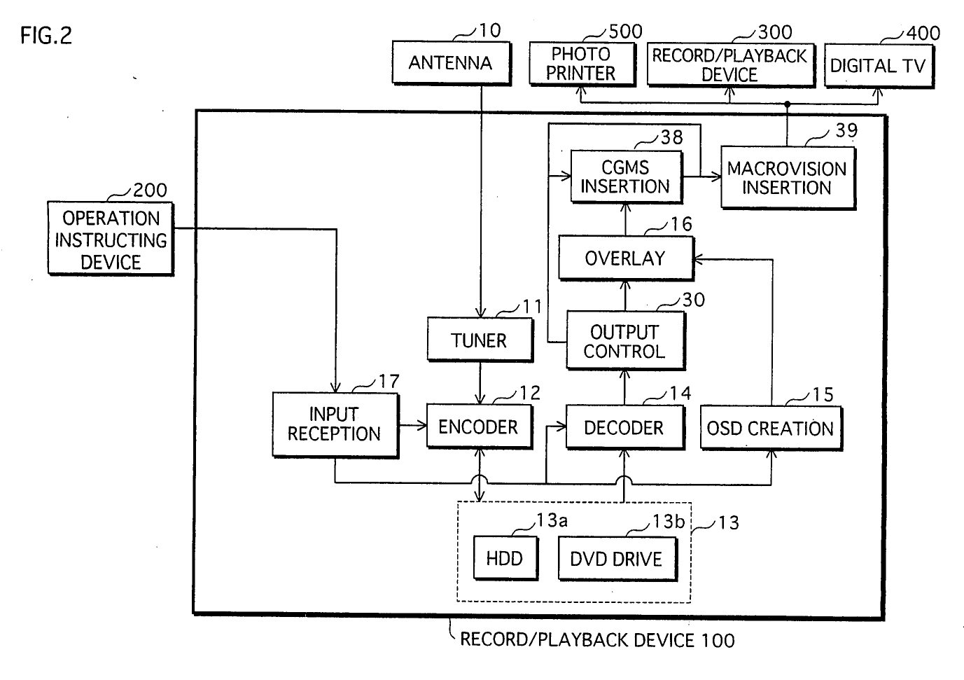

The following description relates to the productivity of RP device 100. FIG. 2 shows the functional blocks of RP device 100. As shown in FIG. 2, RP device 100 includes a tuner 11, an encoder 12, a recording unit 13, a decoder 14, an on-screen display (OSD) creation unit 15, an overlay unit 16, an input reception unit 17, an operation-instructing device 200, a Copy Generation Management System (CGMS) insertion unit 38, a Macrovision insertion unit 39 and an output control unit 30.

RP device 100 is specifically a computer system that includes a microprocessor, a ROM, a RAM, and a hard disk unit. A computer program is stored in the ROM or hard disk unit. RP device 100 functions as a result of the microprocessor operating in accordance with the computer program.

The different components of RP device 100 are described below.

Tuner 11 tunes into specific channels from broadcast waves received by an antenna 10, and sends video contents from the channels to encoder 12.

Encoder 12 encodes video contents sent by tuner 11 using a prescribed recording format.

Recording unit 13 includes a hard disk drive (HDD) 13a and a DVD (digital versatile disk) drive 13b. HDD 13a and DVD drive 13b read/write video contents. This reading/writing includes processing to write video contents sent from encoder 12 via a bus to HD or DVD, and processing to read video contents recorded on HD or DVD and transfer read video contents via the bus. DVD is a removable recording medium, examples of which include rewritable DVDs such as DVD-RAM, DVD-RW and DVD+RW, and recordable DVDs such as DVD-R and DVD+R.

Decoder 14 decodes video contents recorded by recording unit 13.

OSD creation unit 15 creates on-screen displays (OSD). An OSD is a simple graphic drawn using colors shown in a lookup table (LUT) as background colors and character colors.

Specifically, OSD creation unit 15 creates display data that indicates the operation settings and state etc. of RP device 100.

Overlay unit 16 creates an image using a prescribed display format on receipt of indexes and thumbnails created in output control unit 30. Specifically, overlay unit 16 creates a thumbnail screen for a plurality of video contents. For copy-prohibited thumbnails, overlay unit 16 displays an index in the corresponding thumbnail display area. Overlay unit 16 also creates a composite image using a prescribed format by combining display data from OSD creation unit 15 with image data. Note that here a “copy-prohibited thumbnail” is a thumbnail generated from a video content whose copying is prohibited by copy restriction information (described in detail in a later section).

Operation-instructing device 200 receives user instructions relating to dubbing and the like. Device 200 is a remote controller, for example.

Input reception unit 17 receives user inputs from operation-instructing device 200, and controls encoder 12, decoder 14 and OSD creation unit 15 in accordance with received instructions.

CGMS insertion unit 38 inserts CGMS signals in playback signals. Specifically, CGMS insertion unit 38 inserts, for example, one of COPY FREE, COPY ONCE, COPY NO MORE and COPY NEVER in a playback signal. CGMS is a mechanism for managing the generation of copies by embedding copy control information (CCI) in video signals.

Macrovision insertion unit 39 inserts analogue copy protection signals in playback signals. Macrovision is copyright protection technology used when transmitting analog signals. Macrovision prevents illegally copied video contents from being played by disrupting the picture.

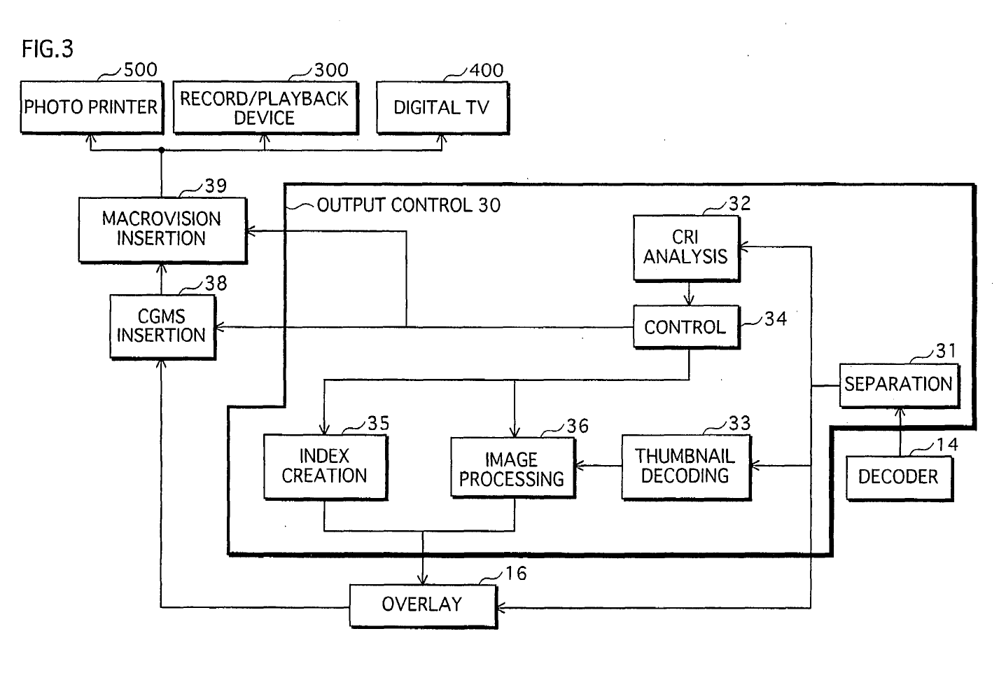

Output control unit 30 performs a thumbnail display control in accordance with the CRI (copy restriction information) of video contents targeted for thumbnail display. FIG. 3 shows the structure of output control unit 30. As shown in FIG. 3, output control unit 30 includes a separation unit 31, a copy restriction information (CRI) analysis unit 32, a thumbnail decoding unit 33, a control unit 34, an index creation unit 35, and an image-processing (IP) unit 36.

Separation unit 31 reads individual video contents recorded by recording unit 13, and separates the AV signals of the video contents, thumbnails corresponding to the AV signals, and CRI corresponding to the thumbnails.

CRI analysis unit 32 analyses the CRI. Specifically, CRI analysis unit 32 analyses whether CRI corresponding to each thumbnail indicates that copying is prohibited, and outputs the result of the analysis to control unit 34.

Thumbnail decoding unit 33 decodes each thumbnail and outputs the decoded image to IP unit 36.

Control unit 34 instructs index creation unit 35 to create and output an index for copy-prohibited thumbnails out of the thumbnails targeted for display on a composite thumbnail screen. Control unit 34 instructs IP unit 36 to output copy-permitted thumbnails. Here, a “composite thumbnail screen” is a thumbnail screen for a plurality of video contents in which both video contents with and without a copy restriction are displayed together on the same screen.

Index creation unit 35 creates an index for each video content to which a copy-prohibited thumbnail relates as instructed by control unit 34. In the present embodiment the index is a title of the video content.

IP unit 36 performs image processing on decoded images received from thumbnail decoding unit 33, and outputs copy-permitted thumbnails to overlay unit 16.

### Data Structure

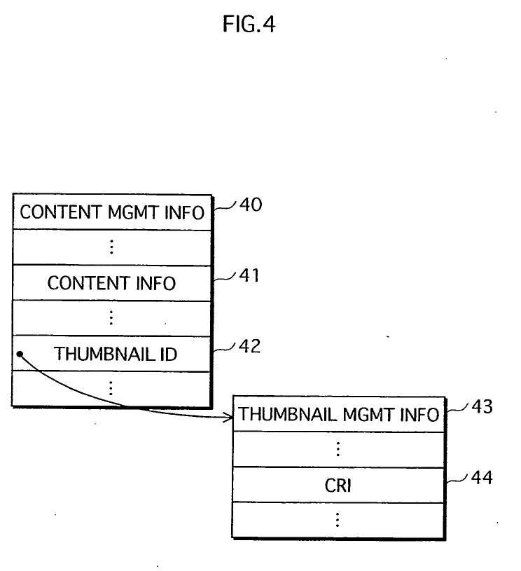

The format structure of a recording medium used by RP device 100 is shown in FIGS. 4 to 6. FIG. 4 shows exemplary content management information (CMI) 40 recorded on the recording medium together with the video contents. CMI 40 includes content information 41 and a thumbnail identifier (ID) 42.

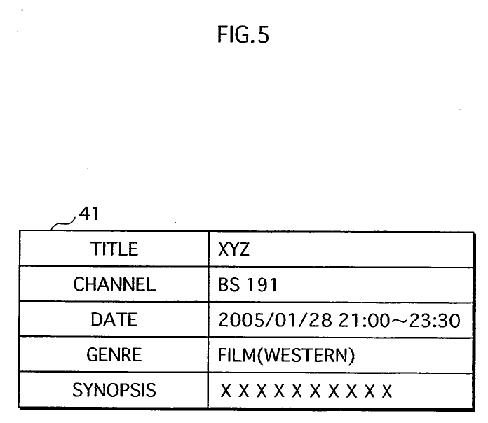

Content information 41, an example of which is shown in FIG. 5, relates to recorded video contents. Content information includes TITLE, CHANNEL, DATE, GENRE, and SYNOPSIS.

TITLE indicates the title of a corresponding video content.

CHANNEL indicates the channel on which the recorded video content was broadcast.

DATE indicates the date (including time) on which the video content was recorded.

GENRE indicates the category to which the recorded video content belongs, and is divided into a main genre and a subgenre (in brackets). Exemplary main genres include FILM, SPORTS etc., while exemplary subgenres include WESTERN, SOCCER, etc.

SYNOPSIS is a summary of what the recorded video content is about.

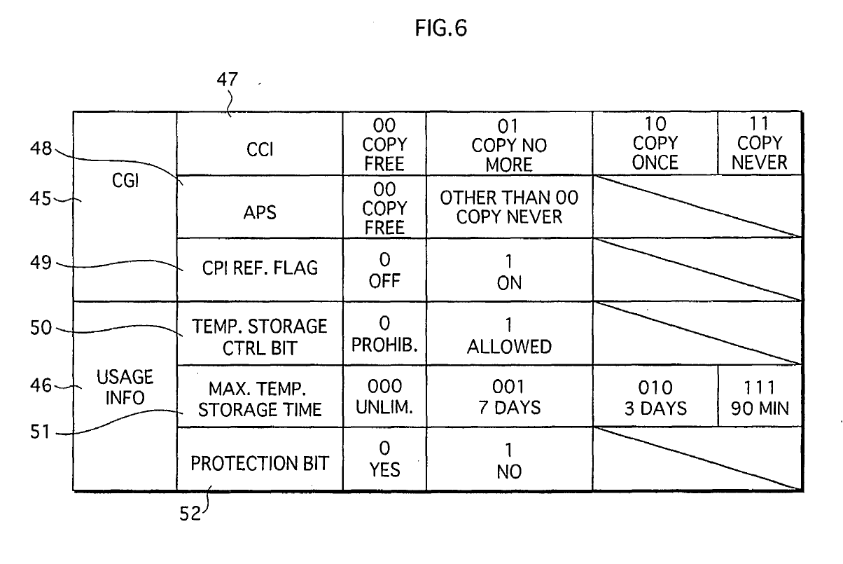

Thumbnail ID 42 identifies the thumbnail of the recorded video content. The thumbnail itself is sub-information relating to the video content, with thumbnail management information (TMI) 43 being referred to hierarchically from CMI 40. TMI 43 includes copy restriction information (CRI) 44. FIG. 6 shows a list of the items included in the CRI. CRI 44 is constituted from copy guard information (CGI) 45 and usage information 46.

CGI 45 is information used in digital video recorders (DVR) to control the copy generation, and includes digital copy control data (i.e. copy control information or “CCI”) 47, analog copy control data (i.e. analog protection system or “APS”) 48, and a content protection information (CPI) reference flag 49.

CCI 47 is binary information for managing the copy generation when recording is performed, with the video content maintained as a digital signal. “00” indicates COPY FREE, “01” indicates COPY NO MORE, “10” indicates COPY ONCE, and “11” indicates COPY NEVER.

APS 48 is binary information for controlling the copy generation when recording is performed, after firstly converting a video content to an analog signal. “00” indicates COPY FREE, while any value other than “00” indicates COPY NEVER.

CPI Reference flag 49 is a flag set to indicate whether to refer to original protection information for the video content, being protection information set by the user for thumbnails other than those preset for use in referencing video contents. “0” indicates that referencing of the original protection information for the video content is not required, and “1” indicates that referencing of the original protection information for the video content is required.

Usage information 46 is information for controlling the recording and output in a DVR, and is used in combination with CGI 45 when controlling the recording and output of video contents. Usage information 46 includes a temporary storage control bit 50, a maximum temporary storage time 51, and an output protection bit 52.

Temporary storage control bit 50 is a flag indicating whether temporary storage of a video content is permitted. If temporary storage control bit 50 is “1” temporary storage is permitted even when CGI 45 indicates COPY NEVER. “0” indicates that temporary storage is not permitted.

Maximum temporary storage time 51 is three-bit information for controlling the maximum temporary storage time period from when a video content is received. For example, “000” indicates unlimited storage, “001” indicates 7 day storage, “010” indicates 3 day storage, and “111” indicates 90 minute storage.

Output protection bit 52 is a flag for controlling the encryption of video contents that include a thumbnail when digitally output. “0” indicates that the video content is to be encrypted irrespective of the CGI and usage information, while “1” indicates that video content is not to be encrypted.

### Operations

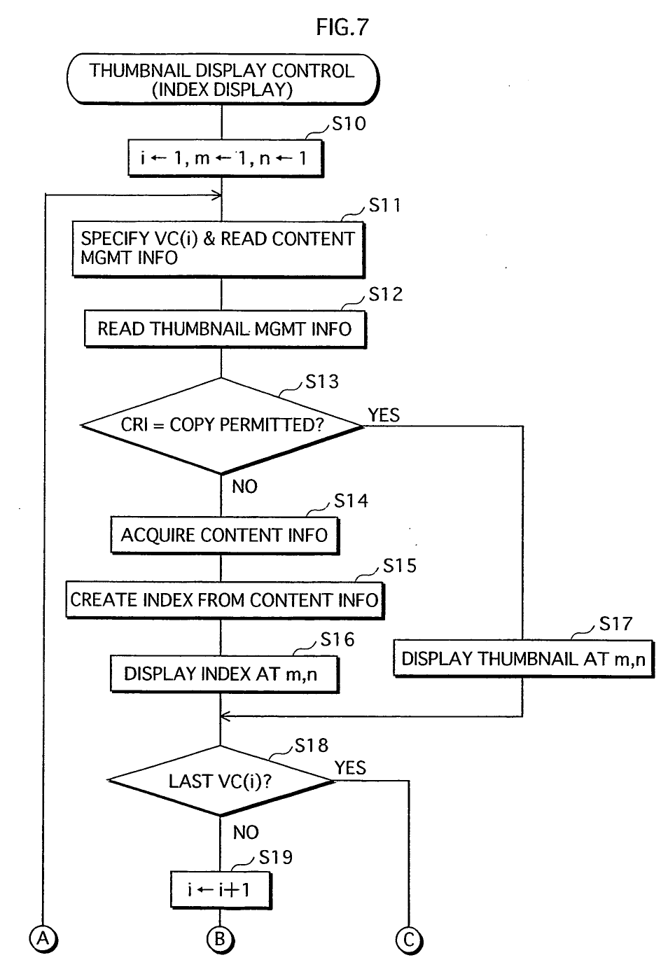

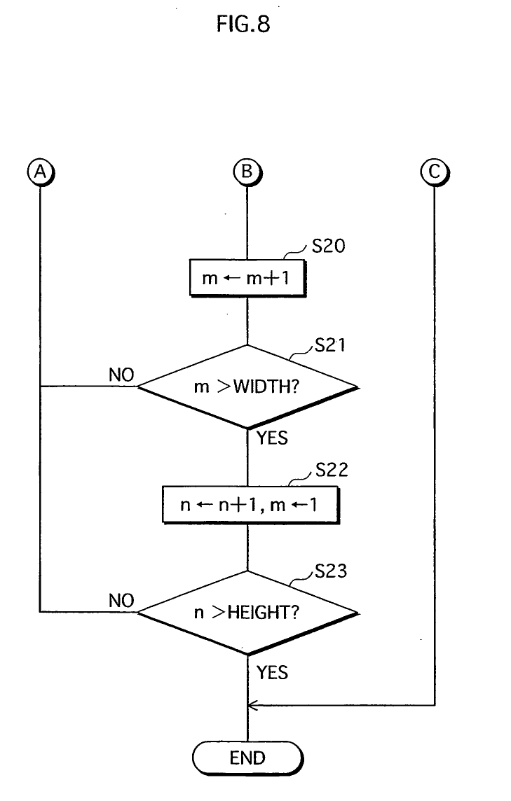

A flowchart for a thumbnail display control in the present embodiment is shown in FIGS. 7 and 8. In this flowchart, VC(i) is a variable specifying the video content targeted for thumbnail display. The column and row for placing the thumbnail are expressed by the notation m^{th} C (i.e. m^{th} column) and n^{th} R (i.e. n^{th} row) using the variables m and n. RP device 100 firstly resets i, m and n (step S10), and then specifies VC(i) targeted for thumbnail display on a composite thumbnail screen and reads the corresponding CMI 40 (step S11). RP device 100 reads TMI 43 referenced from the thumbnail ID in the read CMI 40 (step S12), and judges whether CRI 44 in the read TMI 43 indicates that copying is permitted (step S13). If permitted, RP device 100 displays the thumbnail in the m^{th} C and n^{th} R (step S17) and moves to step S18. If not permitted, RP device 100 reads content information 41 from the read CMI 40 (step S14), creates an index for the thumbnail from the read content information (step S15), and displays the index at the m^{th} C and n^{th} R (step S16). At step S18, RP device 100 judges whether VC(i) is the last video content, and ends the processing if judged to be last. If judged not to be the last, RP device 100 adds “1” to i (step S19), adds “1” to m (step S20), judges whether m exceeds the width of the display area for thumbnails/indexes (step S21), and returns to step S11 if judged in the negative. If judged in the affirmative, RP device 100 resets m, adds “1” to n (step S22), and judges whether n exceeds the height of the display area of thumbnails/indexes (step S23). RP device 100 returns to step S11 if judged in the negative, and ends the processing if judged in the affirmative.

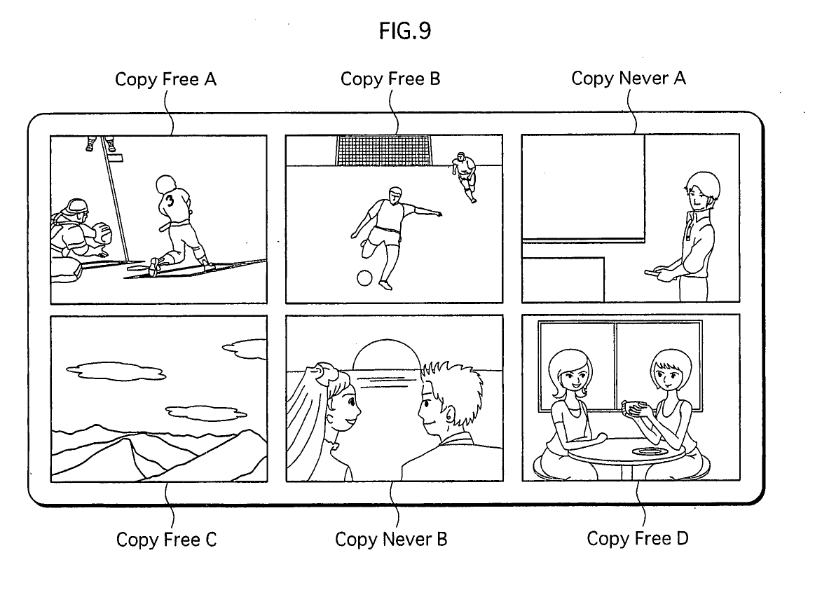

FIG. 9 shows a thumbnail screen for a plurality of video contents when the thumbnail display control is not performed.

Here, COPY FREE A, COPY FREE B, COPY FREE C and COPY FREE D are thumbnails whose copying is permitted (e.g. APS=00), while COPY NEVER A and COPY NEVER B are thumbnails whose copying is prohibited (e.g. APS=01).

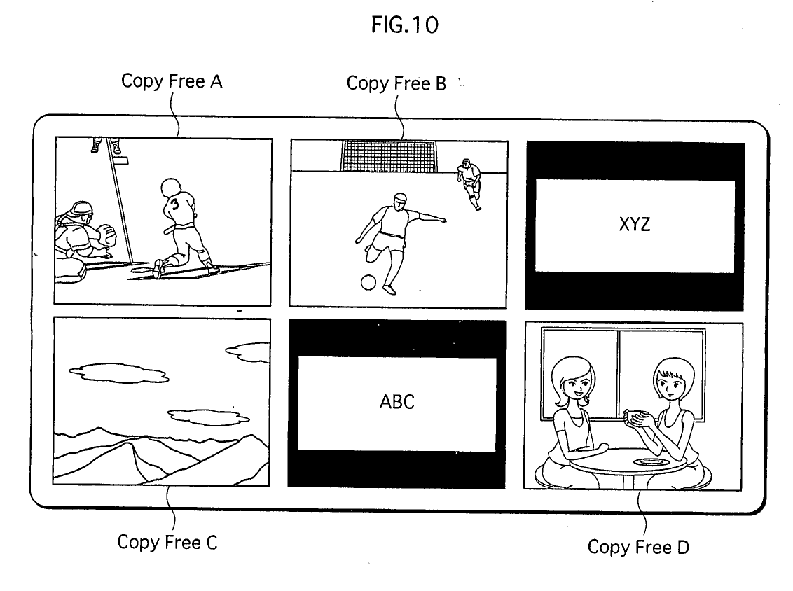

FIG. 10 shows a thumbnail screen resulting from the processing shown in the FIGS. 7 and 8 flowchart being performed on the COPY-FREE and COPY-NEVER thumbnails shown in FIG. 9. In FIG. 10 indexes are displayed for COPY-NEVER thumbnails A and B instead of displaying the thumbnails themselves, which are created by reducing a frame image constituting the respective video contents. In the given example, the title (i.e. included in content information) of the video content is displayed. Here, the titles of COPY NEVER thumbnails A and B are “XYZ” and “ABC”, respectively.

According to the present embodiment, an index is created for a copy-prohibited thumbnail from content information for the video content to which the thumbnail relates, and the index is displayed. A composite thumbnail screen can thus be output while at the same time avoiding the illegal copying of thumbnails.

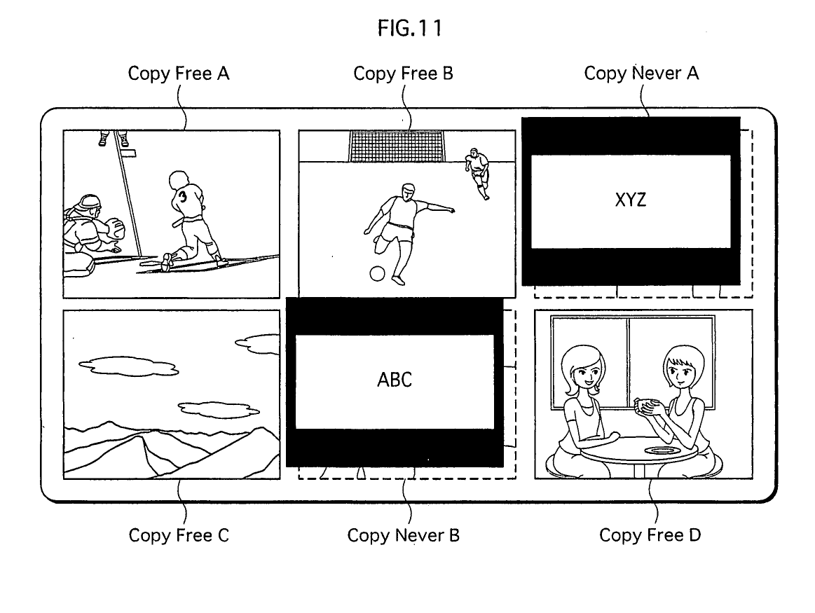

Note that, as shown in FIG. 11, indexes may be displayed by being overlaid on thumbnails obtained by reducing a frame image of respective video contents.

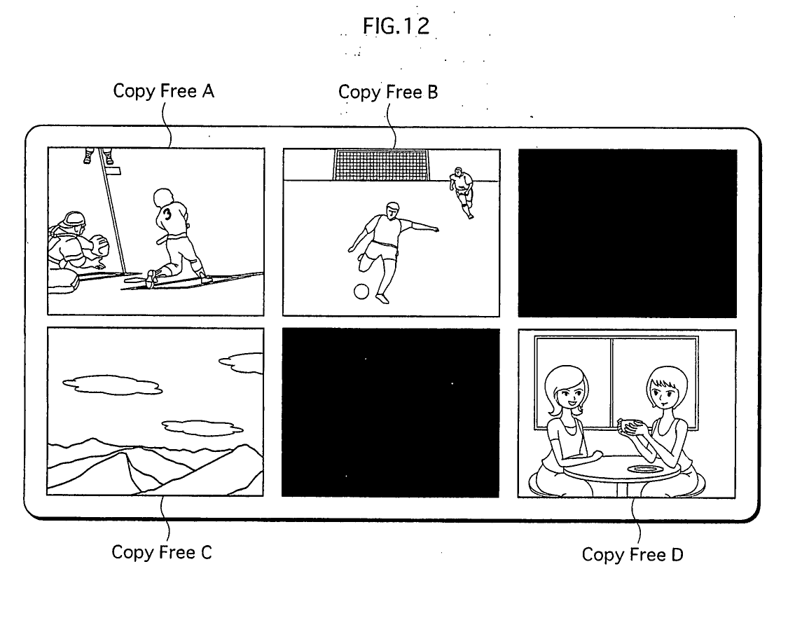

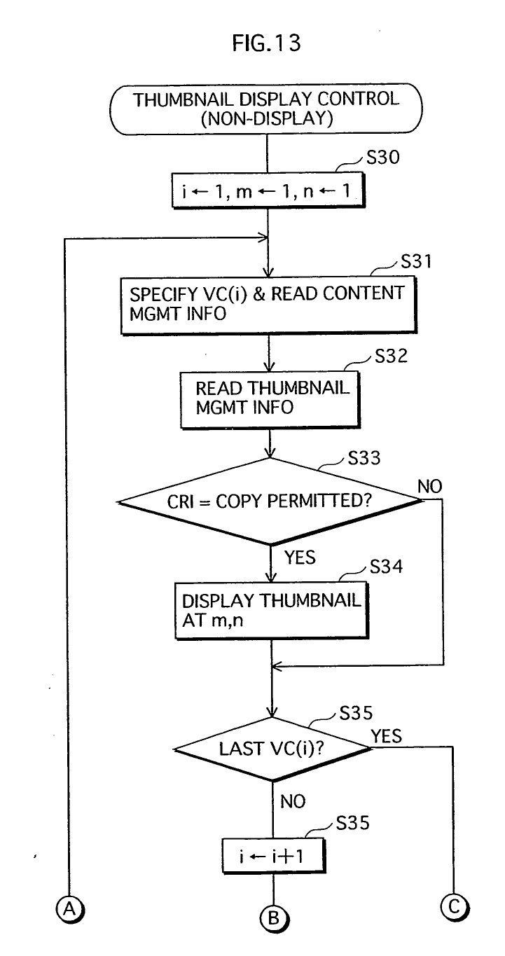

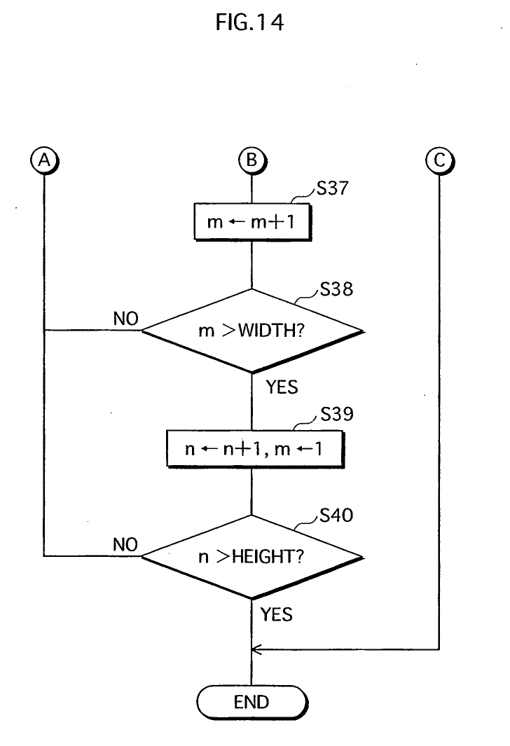

The title of a video content is used as an index in the present embodiment, although it is possible simply to not display copy-prohibited thumbnails. FIG. 12 shows a thumbnail screen in which copy-prohibited thumbnails are not displayed. A flowchart in the case of copy-prohibited thumbnails not being displayed is shown in FIGS. 13 and 14. In this flowchart, VC(i) is a variable indicating the video content targeted for thumbnail display, and the column and row for placing the thumbnail are expressed by the notation m^{th} C (i.e. column) and n^{th} R (i.e. row) using the variables m and n. RP device 100 firstly resets i, m and n (step S30), and then specifies VC(i) targeted for thumbnail display on a composite thumbnail screen and reads the corresponding CMI 40 (step S31). RP device 100 reads TMI 43 referenced from the thumbnail ID in the read CMI 40 (step S32), and judges whether CRI 44 in the read TMI 43 indicates that copying is permitted (step S33). RP device 100 displays the thumbnail in the m^{th} C and n^{th} R if permitted (step S34), and proceeds to step S35 if not permitted. At step S35, RP device 100 judges whether VC(i) is the last video content, and ends the processing if judged to be last. If judged not to be the last, RP device 100 adds “1” to i (step S36), adds “1” to m (step S37), and judges whether m exceeds the width of the display area for thumbnails/indexes (step S38). RP device 100 returns to step S31 if judged in the negative, and resets m and adds “1” to n if judged in the affirmative (step S39). RP device 100 then judges whether n exceeds the height of the display area of thumbnails/indexes (step S40). RP device 100 returns to step S31 if judged in the negative, and ends the processing if judged in the affirmative.

### Embodiment 2

The present embodiment relates to processing performed in RP device 100 to copy a thumbnail screen for a plurality of video contents to another recording medium from the recording medium on which the video contents are recorded. This copying is performed via a screen displayed on digital TV 400. In the given example, the copying is from HD to DVD-RAM. In embodiment 1, a thumbnail screen in which copy-prohibited thumbnails are replaced by indexes is displayed on digital TV 400 at all times, even prior to copying being commenced. When the thumbnail screen is used to select video contents, however, the user will have difficulty intuitively grasping what the video contents are about if indexes are displayed. In view of this, the thumbnail display control in the present embodiment is performed only upon receipt of a user operation instructing the copying of a composite thumbnail screen.

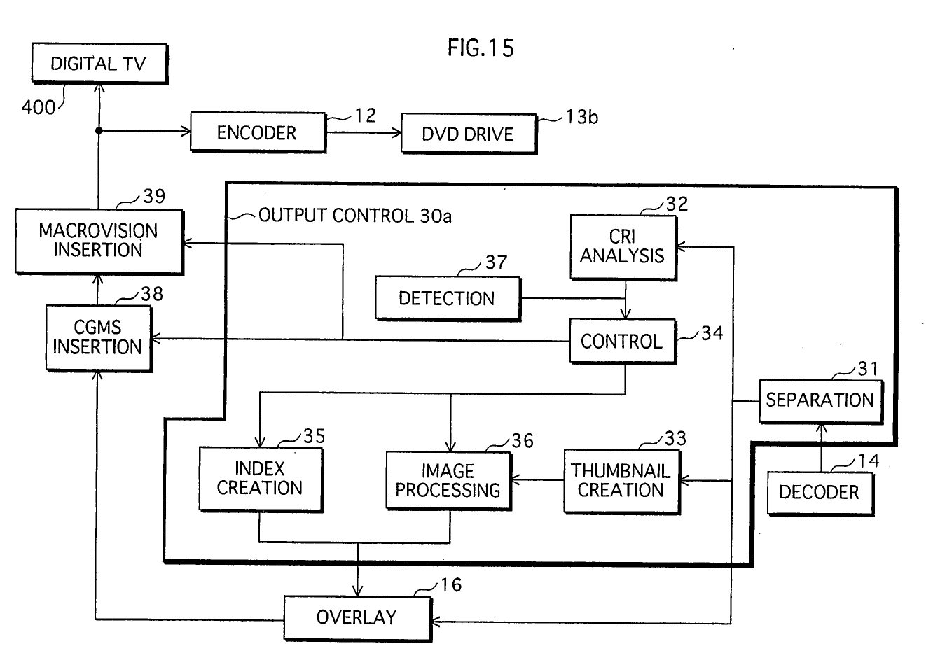

RP device 100 pertaining to the present embodiment is similar in structure to embodiment 1 except for output control unit 30. FIG. 15 shows the structure of an output control unit 30a. In the present embodiment, output control unit 30a includes a detection unit 37.

Detection unit 37 detects a user operation to copy a thumbnail screen (hereinafter “copy operation”) via operation-instructing device 200.

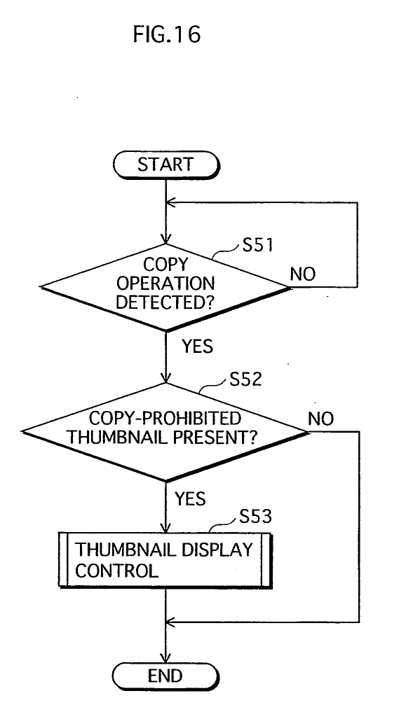

FIG. 16 is a flowchart showing the operations of RP device 100 in embodiment 2. Firstly, on detecting a copy operation by a user (step S51), RP device 100 judges whether the screen currently being displayed includes a copy-prohibited thumbnail (step S52). If there is a copy-prohibited thumbnail, RP device 100 performs the thumbnail display control (step S53), and then initiates the copying. If the screen does not include any copy-prohibited thumbnails, RP device 100 copies the screen in its current state without performing the thumbnail display control.

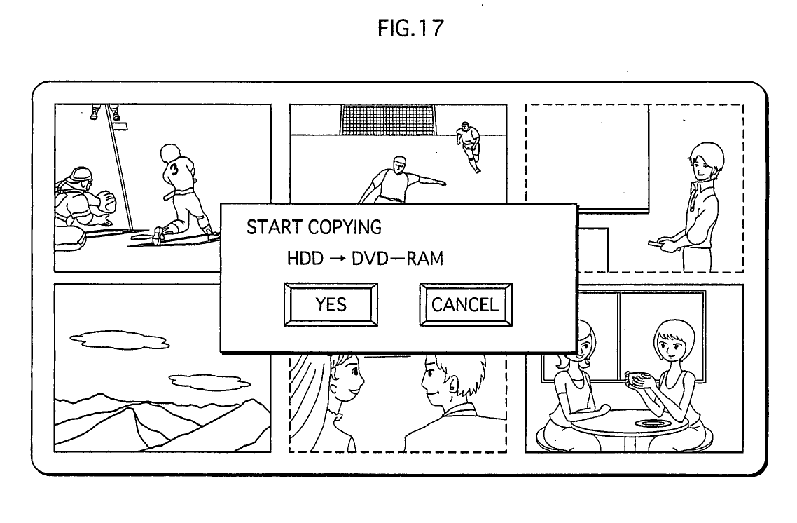

In other words, until a copy operation is detected, copy-prohibited thumbnails and copy-permitted thumbnails are both displayed in the same manner. Then, if a copy operation is detected, RP device 100 performs the thumbnail display control on the copy-prohibited thumbnails according to one of the methods described in embodiment 1. Here, the user is judged to have performed a copy operation if, as shown in FIG. 17 for example, an operation to copy a thumbnail screen from HDD to DVD-RAM is received via a copy start window, with the thumbnails of a plurality of video contents recorded on HDD displayed on the screen. In other words, the thumbnail display control is initiated if YES is selected from the copy start window in FIG. 17 via operation-instructing device 200 or the like.

According to the present embodiment, the thumbnail display control is performed only when a copy operation is received in relation to a composite thumbnail screen. Thus, thumbnail display that is not reliant on copy attributes can be provided at all times except for when a copy operation is performed, while at the same time avoiding the illegal copying of thumbnails. Consequently, fully utilizing the benefits that thumbnails provide in assisting the user to intuitively grasp what individual video contents are about is possible.

Note that while RP device 100, according to the FIG. 16 flowchart, performs the display control to display an index instead of the thumbnail in the case of the screen including a copy-prohibited thumbnail when the copy operation is detected, the display control may be performed by simply not displaying the copy-prohibited thumbnail.

A window may also be displayed to allow the user to select non-display or index display for copy-prohibited thumbnails, and the display control method determined accordingly.

A configuration in which RP device 100 refers to a preset default display control method saved to a nonvolatile memory is also possible.

### Embodiment 3

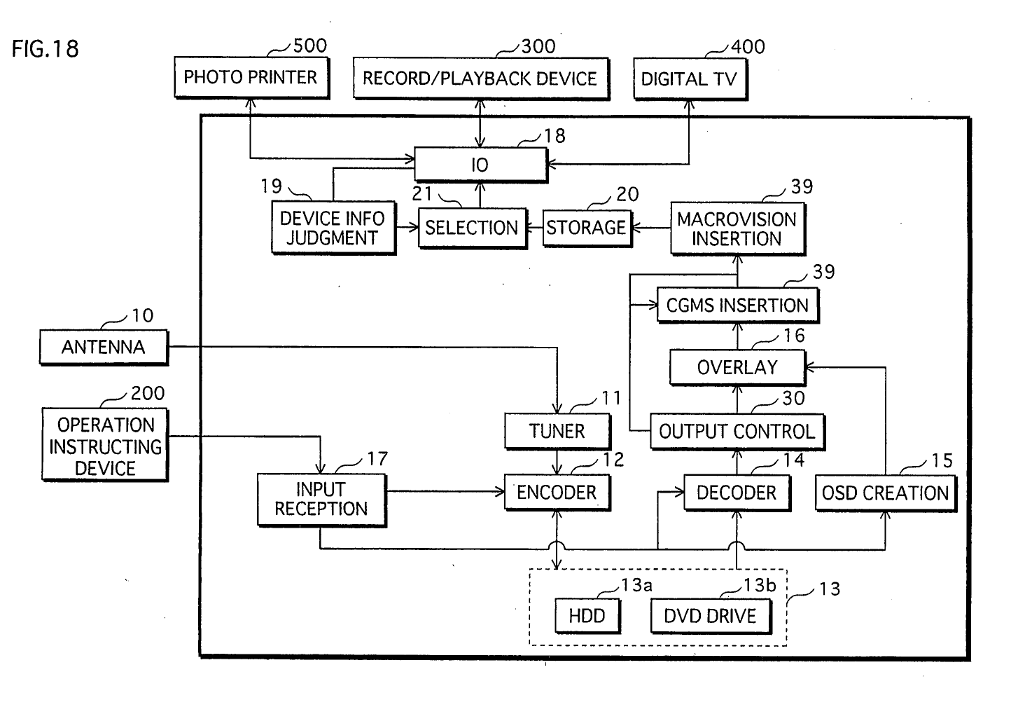

In embodiment 1, controls were performed to display indexes instead of copy-prohibited thumbnails without considering the type of device connected to RP device 100. That is, both digital TV 400 and digital TV 600 connected to RP device 300 display thumbnail screens in which indexes replace copy-prohibited thumbnails. However, the display of indexes despite the device to which the thumbnail screen is output being without a copy function is undesirable as far as the user is concerned. In view of this, the present embodiment relates to switching the display of output images depending on the connected device. That is, if the output destination is a device such as digital TV 400 without a copy function, a frame image of the video contents is reduced to create thumbnails and the thumbnails displayed without considering the CRI (copy restriction information). However, if connected to a device having a copy function (e.g. recording, printing etc.), indexes are displayed instead of copy-prohibited thumbnails. In view of this, RP device 100 as shown in FIG. 18 includes an input/output (IO) unit 18, a device information (DI) judgment unit 19, a storage unit 20, and a selection unit 21.

IO unit 18 outputs a request for acquisition of device information to an external device connected to RP device 100, and receives device information from the external device. IO unit 18 also outputs a thumbnail screen selected by selection unit 21 for each output destination.

DI judgment unit 19 analyzes the device information received from the external device, and judges whether the external device is equipped with a copy function based on a device category code included in the device information.

Storage unit 20 stores a thumbnail screen created without the thumbnail display control being performed, and a thumbnail screen created with the thumbnail display control having been performed (i.e. copy-prohibited thumbnails replaced by indexes).

Selection unit 21 selects one of the stored thumbnail screens for outputting depending on whether the output destination has a copy function. If the output destination has a copy function, selection unit 21 selects the thumbnail screen in which indexes replace copy-prohibited thumbnails. On the other hand, if the output destination does not have a copy function, selection unit 21 selects the thumbnail screen created without performing the thumbnail display control.

### Device Authentication

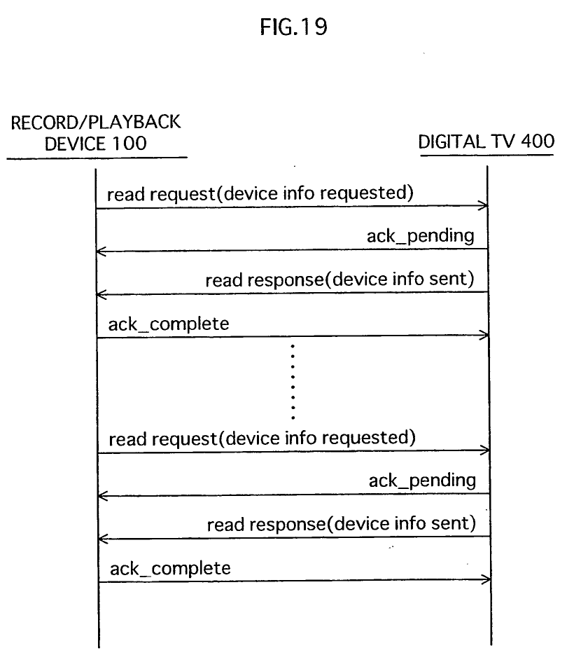

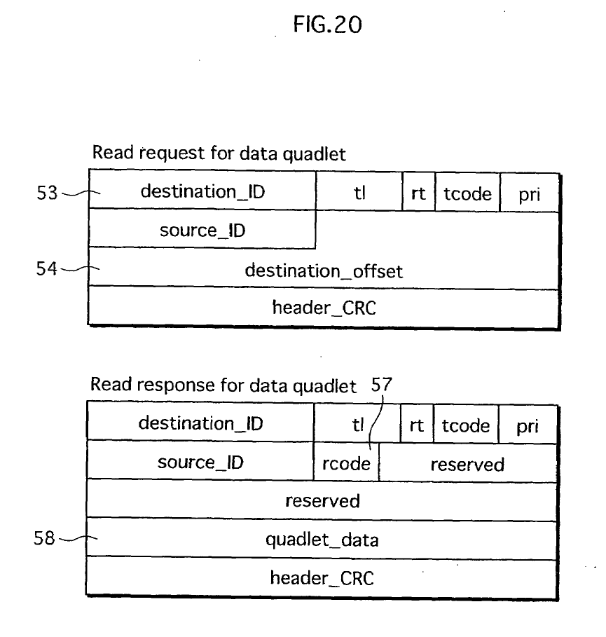

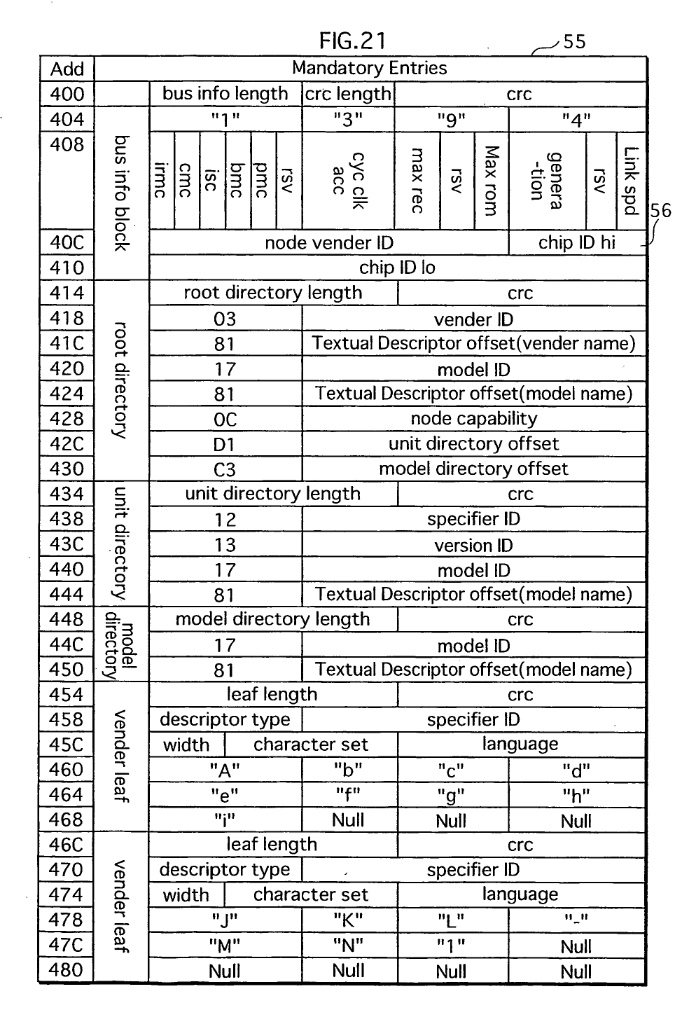

Device authentication is described next. Device authentication is generally performed when an external device is first connected to RP device 100 in order to exclude unauthorized devices. In the present embodiment, RP device 100 extracts a device category code 56 from the device information sent by the external device during device authentication, and judges whether the external device has a copy function based on device category code 56. The communication sequence between the devices at this time is shown in FIG. 19. FIG. 20 shows data transmission both when RP device 100 requests device information and when digital TV 400 sends the requested device information. The transmitted data complies with IEEE standards. Device authentication (i.e. in the case of an IEEE 1394 connection) between RP device 100 and digital TV 400 is given here as an example. Note that device authentication with devices other than digital TV 400 is performed using a similar method. Firstly, RP device 100 requests device information from digital TV 400. Specifically, this involves RP device 100 sending a read request for data quadlet as shown in FIG. 20. This is a request for a single data quadlet (4 byte data) from a designated destination address (destination_ID 53). The addresses (“Add”) shown in FIG. 21 are designated in the target field (destination_offset 54) of the read request. On receipt of the read request for data quadlet, digital TV 400 sends the requested device information to RP device 100. Specifically, this involves digital TV 400 sending a read response for data quadlet as shown in FIG. 20. This read response is in reply to the read request sent by RP device 100. The requested data is stored in a quadlet data field (quadlet_data 58), and the read response also contains a response code (rcode 57). Since the maximum data size transmittable at any one time is 4 bytes, data transmission needs to be repeated depending on the size of the device information. FIG. 21 shows a piece of device information 55 transmitted by digital TV 400. Device information is information specified by IEEE 1212 and unique to each device. Device information 55 includes a Node Vender ID and a Chip ID hi.

The Node Vender ID (company ID) identifies the maker of the device.

Chip ID hi (device category code 56) identifies the product category.

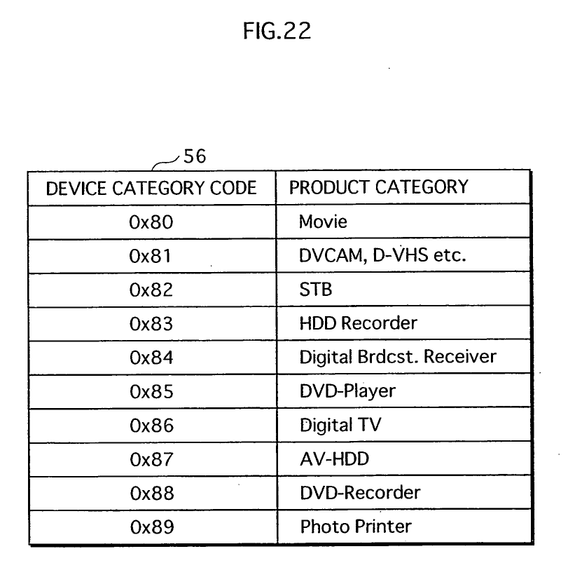

The product category can be determined from the Node Vender ID and the Chip ID hi. RP device 100 uses the product category to judge whether the device has a copy function. FIG. 22 shows exemplary device category codes.

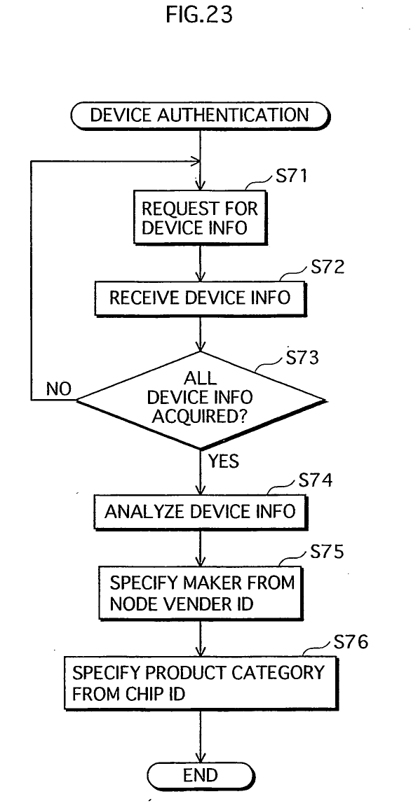

Procedures for device authentication are described here using the FIG. 23 flowchart. Firstly, RP device 100 requests digital TV 400 for device information (step S71), and receives device information from digital TV 400 (step S72). RP device 100 judges whether all the device information has been acquired (step S73). This processing is repeated until all the device information has been acquired, after which RP device 100 analyzes the acquired device information (step S74). This analysis involves firstly identifying the maker of digital TV 400 from the Node Vender ID (step S75) and then identifying the product category from the Chip ID hi (step S76).

“0x86” is identified as the device category code of digital TV 400, and RP device 100 uses this device category code to judges whether digital TV 400 has a copy function. Note that here the existence or otherwise of a copy function is preset for each product category. Since digital TV 400 does not have a copy function, NO COPY FUNCTION is set for digital TVs whose device category code is 0x86. A thumbnail screen created without performing the thumbnail display control is thus output to digital TV 400.

In the present embodiment, RP device 100 outputs a thumbnail screen for a plurality of video contents without performing the thumbnail display control when the output destination does not having a copy function, as a result of performing device authentication with external devices connected thereto. On the other hand, RP device 100 performs the thumbnail display control in the case of the external device having a copy function, and outputs a thumbnail screen in which indexes replace copy-prohibited thumbnails. In other words, RP device 100 outputs a thumbnail screen created without performing the thumbnail display control to digital TV 400, and outputs a thumbnail screen displaying indexes to digital TV 600 via RP device 300. Thus, convenience to the user can be improved while at the same time protecting the rights of the copyright holder.

### Embodiment 4

In embodiment 1, RP device 100 creates a thumbnail screen for a plurality of video contents and outputs the thumbnail screen to digital TV 400. In the present embodiment, RP device 100 creates a thumbnail for each video content, and outputs the thumbnails to digital TV 400 along with content information and CRI (copy restriction information) for respective video contents. Digital TV 400 creates indexes according to the received CRI and creates a thumbnail screen.

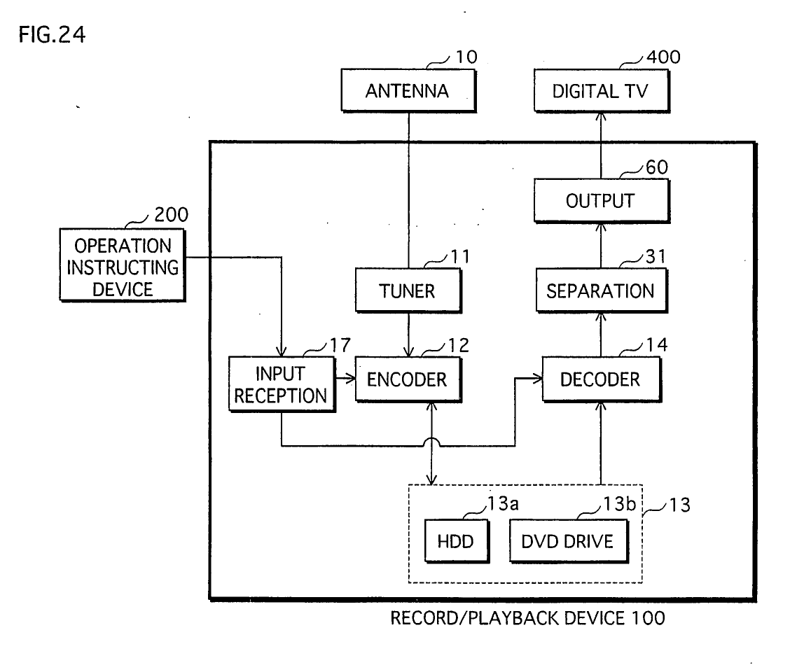

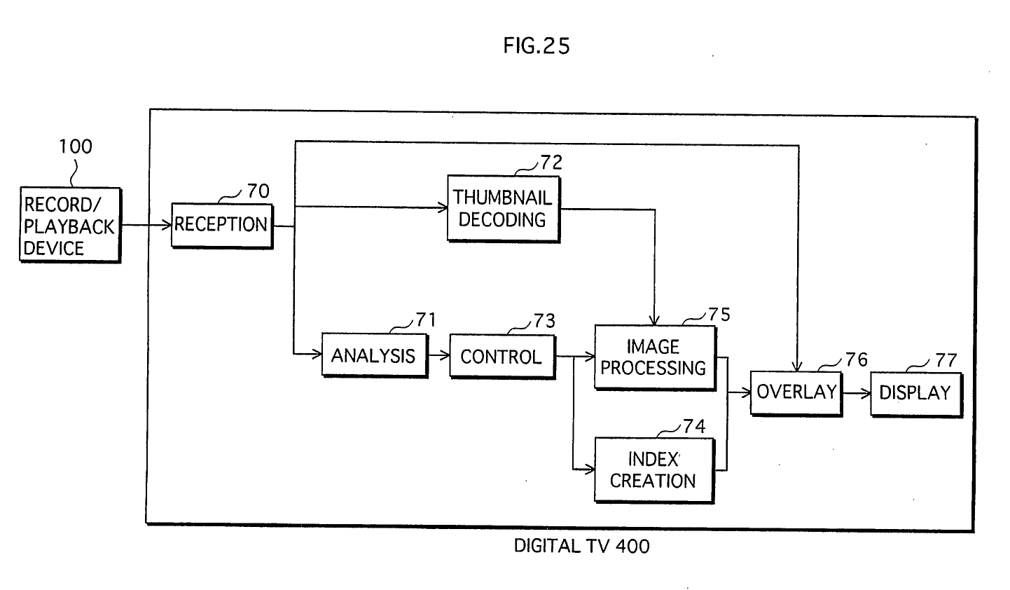

The functional blocks of RP device 100 and digital TV 400 pertaining to the present embodiment are shown in FIGS. 24 and 25, respectively.

RP device 100 includes tuner 11, encoder 12, recording unit 13, decoder 14, separation unit 31, an output unit 60, operation-instructing device 200, and input reception unit 17.

Output unit 60 outputs to digital TV 400 audio-visual (AV) signals, thumbnails corresponding to the AV signals, CRI corresponding to the thumbnails, and content information relating to respective video contents.

The other components are similar to embodiment 1.

Digital TV 400 specifically includes a microprocessor, a ROM and a RAM, with a computer program being stored in the ROM. Digital TV 400 functions as a result of the microprocessor operating in accordance with the computer program.

Digital TV 400 includes a reception unit 70, a copy restriction information (CRI) analysis unit 71, a thumbnail decoding unit 72, a control unit 73, an index creation unit 74, an image-processing (IP) unit 75, an overlay unit 76, and a display unit 77.

Reception unit 70 receives AV signals, thumbnails, content information and CRI sent by RP device 100.

CRI analysis unit 71 analyses the received CRI. Specifically, CRI analysis unit 71 analyzes whether CRI corresponding to each thumbnail has a copy-prohibited attribute, and outputs the analysis result to control unit 73.

Thumbnail decoding unit 72 decodes each thumbnail and outputs the decoded images to IP unit 75.

Control unit 73 instructs index creation unit 74 to create and output indexes for video contents to which copy-prohibited thumbnails relate out of the thumbnails targeted for display on a composite thumbnail screen, and instructs IP unit 75 to output copy-permitted thumbnails.

Index creation unit 74 creates an index for each video content to which a copy-prohibited thumbnail relates as instructed by control unit 73. In the present embodiment, the index is a title of the video content.

IP unit 75 performs image processing on decoded images received from thumbnail decoding unit 72, and outputs copy-permitted thumbnails to overlay unit 76.

Overlay unit 76 receives indexes from index creation unit 74 and thumbnails from IP unit 75, and creates an image (i.e. thumbnail screen) using a prescribed display format.

Display unit 77 displays the created thumbnail screen.

The present embodiment thus enables digital TV 400 to create a thumbnail screen.

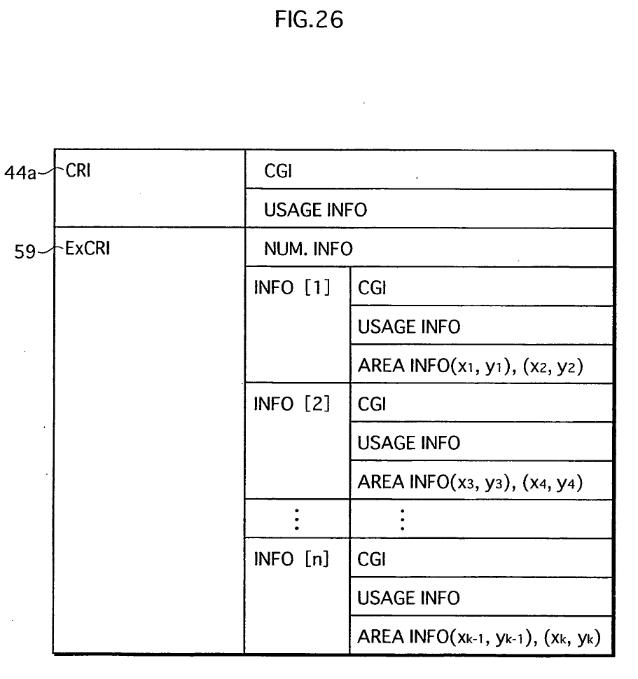

Note that extended CRI 59 (i.e. extension of CRI) may be transmitted to digital TV 400. Extended CRI 59, an example of which is shown in FIG. 26, includes number information and area information.

Number information shows the number of thumbnails for display.

Area information shows the area in which respective thumbnails are to be displayed.

Extended CRI 59 holds CGI (copy guard information) for each thumbnail in correspondence with area information. On receipt of extended CRI 59, digital TV 400 analyses the CGI for each thumbnail. If the CGI indicates that copying is prohibited, digital TV 400 displays an index in the area shown by the area information. Consider an example in which the number information is “6”. Information[1], Information[2] and Information[3] are placed from left to right at the top half of the screen, and Information[4], Information[5] and Information[6] are placed from left to right at the bottom half of the screen. Here, it is assumed that the CGI for Information[3] and Information[5] shows COPY NEVER, while the CGI for Information[1], Information[2], Information[4] and Information[6] shows COPY FREE. Digital TV 400 firstly analyzes the CGI relating to Information [1]. Given that the CGI of Information[1] shows COPY FREE, digital TV 400 displays a thumbnail in the area indicated by the area information of Information[1]. Information[2] is processed in the same manner. Digital TV 400 then analyzes the CGI relating to Information[3]. Given that the CGI of Information[3] shows COPY NEVER, Digital TV 400 displays an index in the area indicated by the area information of Information[3]. Information[4], Information[5] and Information[6] are processed in the same manner. That is, thumbnails are displayed for Information[4] and Information[6] whose CGI shows COPY FREE, while an index is displayed for Information[5] whose CGI shows COPY NEVER. Thus, the thumbnail screen shown in FIG. 10 can also be obtained using extended CRI 59. The thumbnail screen shown in FIG. 12 can be obtained by not displaying the thumbnails rather than displaying indexes. Alternatively, the thumbnail screen shown in FIG. 11 can be obtained by overlaying indexes on thumbnails.

### Embodiment 5

Embodiment 4 was described in terms of a thumbnail screen being created by digital TV 400 rather than RP device 100. Embodiment 5 relates to a method for using BML (broadcast markup language) in realizing embodiment 4. In the present embodiment, RP device 100 outputs thumbnails, CRI (copy restriction information), content information and BML documents to digital TV 400. Digital TV 400 uses the BML documents to display the thumbnails. Digital TV 400 in the present embodiment thus requires a BML browser. BML is a page description language geared towards data broadcasting, and is able to stipulate spatial and temporal time presentation controls for indicating what to display and where. BML documents are interpreted and processed by the BML browser.

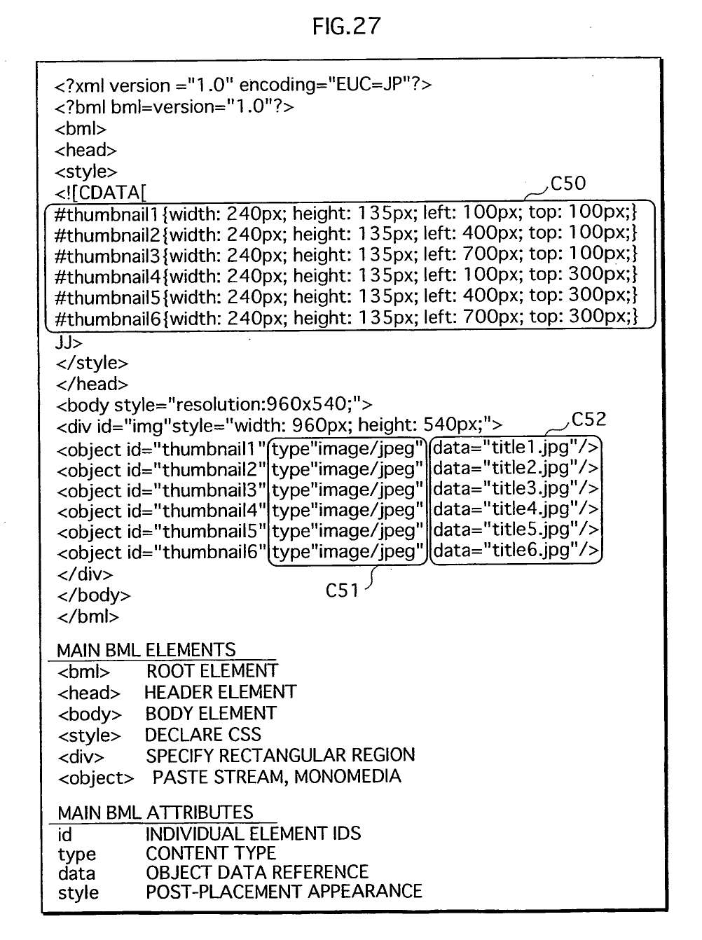

An exemplary display format for still images that use BML is shown in FIG. 27. C50 shows position information and sizes for displaying thumbnails. C51 shows data classifications for the thumbnail data in C52. The data classifications include JPEG (Joint Photographic experts Group), BMP (BITMAP), and GIF (Graphic Interchange Format) formats. C52 shows thumbnail data information.

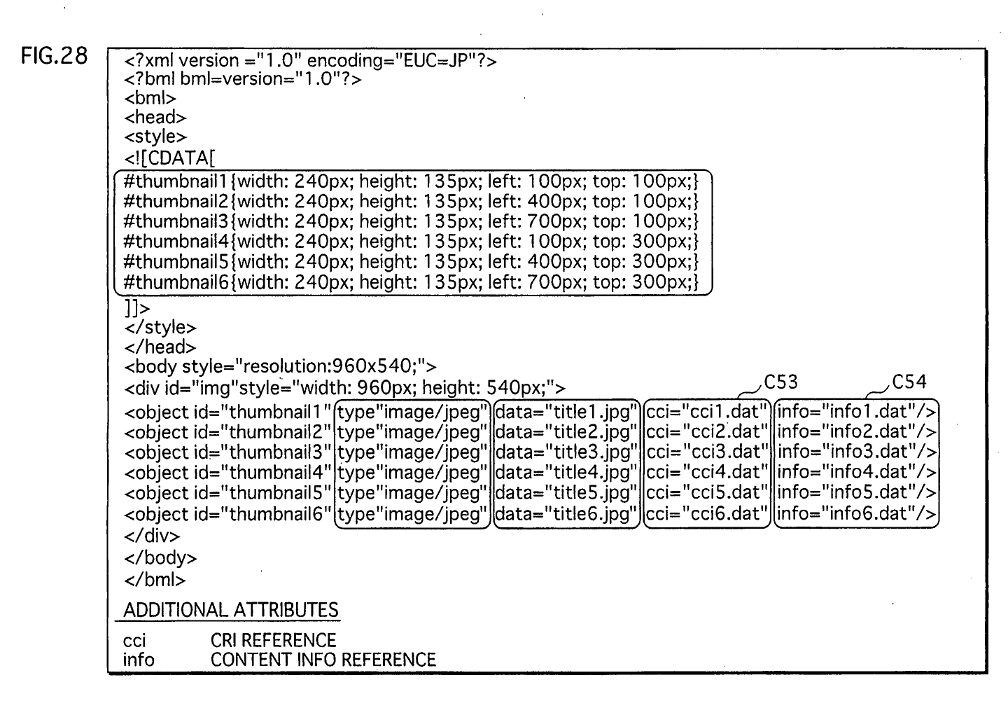

The thumbnail display control is described next in the case of embodiment 4 being realized using BML. To display indexes instead of copy-prohibited thumbnails, the CRI and content information description in FIG. 28 is added to the description in FIG. 27. C53 shows the CRI of video contents. This CRI is, for example, CCI (copy control information). C54 shows the content information. Digital TV 400 refers to the content information and creates an index for copy-prohibited thumbnails.

According to the present embodiment, BML can be used to realize display controls for displaying indexes in place of copy-prohibited thumbnails with respect to a thumbnail screen for a plurality of video contents.

### Modifications

RP device 100 pertaining to the present invention is described above based on the preferred embodiments, although the present invention is, of course, not limited to these embodiments.

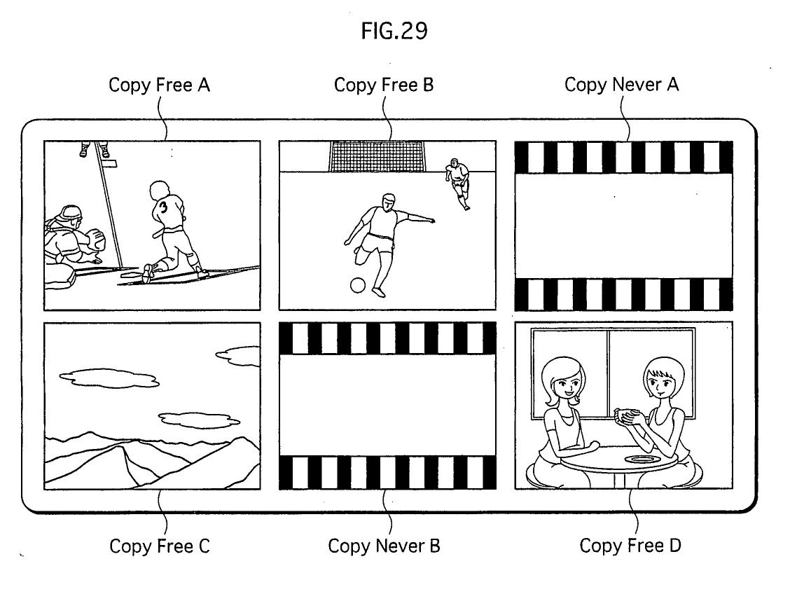

In the preferred embodiments, the titles of video contents to which copy-prohibited thumbnails relate are used as indexes, although the present invention is not limited to this. Character strings may be used, as may figures. The synopsis of the video content may also be used, for example, along with the recording date, broadcast time, recording mode, or genre of the video content, or even information indicating that copying of the video content is prohibited. FIG. 29 shows a thumbnail screen in which figures expressing the genre of video contents are displayed instead of copy-prohibited thumbnails.

In the preferred embodiments, display controls are performed according to the CRI of thumbnails, although the present invention is not limited to this. For example, the thumbnail display control may be performed in combination with a parental lock attribute that depends on the user of the copy destination (i.e. recording medium).

In the above embodiments, HD and DVD are used as recording media, although the present invention is not limited to this. For example, other optical disks such as Blu-Ray Disc (BD), CD-R and CD-RW, or magnetic optical disks such as magneto-optical (MO) and phase-change disks (PD) may be used. Semiconductor memory cards may also be used, including secure digital (SD) memory cards, Compact Flash Cards, SmartMedia, Memory Stick, Multimedia Cards, and PCM-CIA. Alternatively, magnetic recording disks such as SuperDisk, Zip and Clik!, or removable HDDs such as ORB, Jaz, SparQ, SyJet and EZFley may be used.

The above embodiments are described in terms of a system in which two recording media are mountable in a single RP device, although the present invention is not limited to this. For example, the system may include two or more recording media, each constituted by a single RP device.

Although an RP device is used in the preferred embodiments, the present invention may be any of a method that includes the steps shown in the flowcharts, a computer program that includes program code for having a computer execute the steps shown in the flowcharts, and a computer-readable recording medium storing the computer program.

In the preferred embodiments, an RP device has connected thereto another RP device, a digital TV and a photo printer, although the present invention is not limited to this. Other devices may be used, including a playback-only device and a personal digital assistant (PDA), for example.

In the preferred embodiments, thumbnails are created externally to RP device 100 by reducing a frame image of video contents, and included in video contents handled by RP device 100, although the present invention is not limited to this. In the case of thumbnails not being included in video contents, for example, RP device 100 may create the thumbnails internally by reducing a frame image of video contents.

### INDUSTRIAL APPLICABILITY

A playback device constituting the present invention can be administratively, as well as continuously and repeatedly manufactured and retailed in manufacturing industries.

1. A playback device for playing a video content selected from a plurality of video contents, comprising:
a first creating unit operable to create a thumbnail for each video content without a copy restriction by reducing a frame image constituting the video content;
a second creating unit operable to create an index for each video content with a copy restriction by using one of a character string and a figure that relate to the video content; and
an output unit operable to output to another device a thumbnail screen obtained by arranging thumbnails created by said first creating unit and indexes created by said second creating unit.

2. The playback device of claim 1, wherein
the character string indicates one of a title and a broadcast date of the video content, and
the figure indicates one of a genre of the video content and that copying of the video content is prohibited.

3. The playback device of claim 2, wherein
the video content is a broadcast content, and
said playback device further comprises a receiving unit operable to receive content information indicating the title, broadcast date and genre of the video content.

4. The playback device of claim 1 further comprising a judging unit operable to judge whether the other device has a copy function that includes at least one of recording and printing the thumbnail screen, wherein
said output unit outputs the thumbnail screen obtained by arranging thumbnails and indexes created by said first and second creating units if the other device is judged to have the copy function.

5. The playback device of claim 4 further comprising a detecting unit operable to detect a device category of the other device at a time of connecting with the other device, wherein
said judging unit performs the judgment based on the detected device category.

6. The playback device of claim 4 further comprising a third creating unit operable to create a thumbnail for each video content with a copy restriction by reducing a frame image constituting the video content, wherein
said output unit outputs a thumbnail screen obtained by arranging thumbnails created by said first and third creating units to the other device only if judged not to have the copy function.

7. The playback device of claim 1 further comprising a detecting unit operable to detect copy restriction information from each video content, wherein
a video content whose detected copy restriction information indicates one of COPY NO MORE and COPY NEVER is a video content with a copy restriction, and
a video content whose detected copy restriction information indicates one of COPY FREE and COPY ONCE is a video content without a copy restriction.

8. The playback device of claim 1 further comprising a recording medium on which the plurality of video contents are recorded.

9. The playback device of claim 1 further comprising:
a third creating unit operable to create a thumbnail for each video content with a copy restriction by reducing a frame image constituting the video content; and
a detecting unit operable to detect a copy operation, wherein
said output unit outputs the thumbnail screen obtained by arranging thumbnails created by said first and third creating units until the copy operation is detected, and outputs the thumbnail screen obtained by arranging thumbnails and indexes created by said first and second creating units if the copy operation is detected.

10. A display device used in a system that includes a playback device, comprising:
a receiving unit operable to receive from said playback device a thumbnail, content information and copy restriction information that relate to each of a plurality of video contents;
a judging unit operable to judge whether the video content has a copy restriction by referring to the copy restriction information;
an index creating unit operable, if judged in the affirmative, to create an index using one of a character string and a figure included in the content information; and
a display unit operable to display a thumbnail screen obtained by arranging thumbnails received by said receiving unit and indexes created by said index-creating unit.

11. The display device of claim 10, wherein said receiving unit receives thumbnails created in said playback device by a thumbnail creating unit operable to create a thumbnail for each video content by reducing a frame image constituting the video content, and output from said playback device by an output unit operable to output the created thumbnail to said display device along with content information and copy restriction information that relate to the video content.

12. A method for playing a video content selected from a plurality of video contents, comprising the steps of:
creating a thumbnail for each video content without a copy restriction by reducing a frame image constituting the video content;
creating an index for each video content with a copy restriction by using one of a character string and a figure that relate to the video content; and
outputting a thumbnail screen obtained by arranging created thumbnails and indexes to another device.

13. A computer program for playing a video content selected from a plurality of video contents, comprising program code operable to cause a computer to:
create a thumbnail for each video content without a copy restriction by reducing a frame image constituting the video content;
create an index for each video content with a copy restriction by using one of a character string and a figure that relate to the video content; and
output a thumbnail screen obtained by arranging created thumbnails and indexes to another device.

14. A recording medium storing a computer program for playing a video content selected from a plurality of video contents, said computer program comprising program code operable to cause a computer to:
create a thumbnail for each video content without a copy restriction by reducing a frame image constituting the video content;
create an index for each video content with a copy restriction by using one of a character string and a figure that relate to the video content; and
output a thumbnail screen obtained by arranging created thumbnails and indexes to another device.
